(19) United States
(12) Patent Application Publication
(10) Pub. No.: US 2022/0397490 A1
(43) Pub. Date: Dec. 15, 2022

(54) PROTECTIVE HOUSING FOR A MICROTOME BLADE, ARRANGEMENT COMPOSED OF A PROTECTIVE HOUSING AND MICROTOME BLADE, AND MICROTOME BLADE HOLDER

(71) Applicant: LEICA BIOSYSTEMS NUSSLOCH GMBH, Nussloch (DE)

(72) Inventor: Roland WALTER, Reilingen (DE)

(21) Appl. No.: 17/776,786

(22) PCT Filed: Nov. 11, 2020
(86) PCT No.: PCT/EP2020/081702

§ 371 Date: May 13, 2022

(30) Foreign Application Priority Data
Nov. 15, 2019 (DE) 10 2019 130 995.6

(51) Int. Cl. G01N 1/06; B26D 7/26; B26D 7/22

(52) U.S. Cl. CPC G01N 1/06; B26D 7/2614; B26D 7/22; G01N 2001/061

(57) ABSTRACT

A protective housing for a microtome blade (4) includes a frame that holds the microtome blade (4) and a clip (2) that can be pivoted relative to the frame. In a first position, the clip (2) covers a cutting edge of the microtome blade (4) received in the frame. A microtome blade holder (6) is configured to receive an arrangement (100) composed of the protective housing and the microtome blade (4).

### CROSS-REFERENCE TO RELATED APPLICATIONS

The present application is the U.S. national phase of International Application No. PCT/EP2020/081702 filed Nov. 11, 2020, which claims priority to German Application No. 10 2019 130 995.6 filed Nov. 15, 2019, the entire disclosures of which are incorporated herein by reference.

### FIELD OF THE DISCLOSURE

The present invention relates to a protective housing for a microtome blade, to an arrangement composed of protective housing and microtome blade, and to a microtome blade holder for receiving such an arrangement.

### BACKGROUND OF THE DISCLOSURE

Microtomes are devices for cutting very thin sections. In particular in preparation for microscopy, it is often necessary to make thin sections. A section thickness is typically between 0.1 and 100 μm. The materials used are primarily soft materials or materials, for example from biology, medicine, or the analysis of plastics materials.

Cryostat microtomes or cryostats, in which the tissue is frozen so that it can be sectioned properly, are often used to cut very soft tissue.

A microtome usually consists of a knife block or blade carrier in which a blade or knife can be clamped in an exchangeable manner. Furthermore, a microtome has a specimen holder having a sample. Depending on the type of microtome, the sample or the knife is moved during cutting. In this way, a wafer-thin layer can be cut off. The section thickness is adjustable.

In automated microtomes, a feed mechanism can automatically shift incrementally so that sections of equal thickness can be produced.

Since the blade usually has to be replaced by hand, there is a risk of injury at this point. Blades are usually removed individually from the usual blade dispensers and integrated into the blade carrier. The sharp blade must be touched with the fingers. Furthermore, there is also a risk of injury in the blade carrier when the section is removed or the blade carrier is cleaned. In most cases, the blade is then manually covered by a finger guard.

If a person forgets to place the finger guard on the blade, there is a high risk of injury from the blade in the clamped state.

The object of the invention is therefore to reduce the risk of injury from the blade when working with the microtome and to achieve additional protection when the blade is inserted on the blade holder.

### SUMMARY OF THE DISCLOSURE

According to the invention, a protective housing for a microtome blade, an arrangement having a protective housing and a microtome blade, and a microtome blade holder having the features of the independent claims are proposed. Advantageous configurations are the subject matter of the dependent claims and the following description.

The invention makes use of the measure of providing a protective housing for a microtome blade having a frame for receiving a microtome blade and a clip that can be pivoted relative to the frame in order to cover a cutting edge of the microtome blade in a first position.

In this way a moveable clip is provided which covers the cutting edge when handling the blade. This minimizes the risk of injury both when inserting the protective housing with the microtome blade into a blade holder and when manipulating the specimen head, removing sections, or cleaning the blade carrier.

In an advantageous embodiment, the clip can be pivoted into a second position in which it does not cover the cutting edge when a microtome blade is received in the frame. In this way, the protective housing can be advantageously used together with the microtome blade for cutting operations without the protective housing having to be removed.

Preferably, a covering surface of the clip, which covering surface covers a microtome blade in the first position, when inserted, is offset perpendicular to a blade plane by 0.1 to 3 mm in the second position. This distance is advantageous because it is sufficient to allow the cutting edge to be available for cutting operations but is still small enough to allow the clip to protect against injuries on the cutting edge. In addition, in this position, the clip can prevent the material that has been cut from rolling up.

The clip is expediently latched to the frame in the first and/or second position. This is advantageous because the first and/or second position can be set exactly in this way.

In particular, the clip is fastened to the frame by means of hinges which are preferably designed as film hinges. This is advantageous because, in this way, the clip can be pivoted relative to the frame in a simple manner.

Provision can be made for the microtome blade to be non-detachably connected to the protective housing, for example for the microtome blade to be overmolded with a protective housing.

The protective housing or the frame is preferably also open on an insertion side for the microtome blade. In this way, the microtome blade can advantageously be easily inserted into the protective housing.

The frame expediently has two guide rails into which the microtome blade can be inserted. A microtome blade can be easily inserted into or removed from the protective housing through the two guide rails.

The guide rails are preferably designed as elongated slots or grooves which are preferably open on one side for inserting a microtome blade and on the other side have a stop which, when a microtome blade is inserted, is on the side where the cutting edge is located. In this way, the microtome blade can be inserted into the protective housing in a simple manner and yet very precisely. Another advantage is that the distance between the cutting edge and the clip is precisely defined, so that the housing is also suitable for blades with different blade plane widths.

At least one of the guide rails expediently has a latching lug into which the microtome blade can be latched. For this purpose, the microtome blade preferably has a corresponding indentation or recess into which the latching lug can latch. In this way, an unintentional slipping of the microtome blade in the protective housing is advantageously avoided.

In particular, the clip has a U-shape, with the frame or the entire protective housing preferably also having a U-shape. This is a particularly good shape to ensure cutting edge coverage and minimal size at the same time.

The protective housing is expediently made of plastics material. This is advantageous because plastics material is inexpensive and easy to work with.

In particular, the protective housing is designed as a one-piece injection molded part. In this way, the protective housing can be manufactured in a particularly simple and inexpensive manner.

According to a further aspect of the invention, a microtome blade holder is proposed which is set up to receive an arrangement composed of a protective housing according to the invention and a microtome blade. In particular, this microtome blade holder has a mechanism, such as a latching lug, which is adapted, when an arrangement composed of a protective housing according to the invention and a microtome blade is received, to automatically press the clip from the first position to the second position. In this way, the protective housing can be provided with the clip in the first position and, when the protective housing is inserted into the microtome blade holder, it is automatically ensured that the clip is pivoted into the second position.

Further advantages and refinements of the invention result from the description and the accompanying drawings.

It goes without saying that the features mentioned above and those still to be explained below can be used not only in the combination specified in each case, but also in other combinations or on their own, without departing from the scope of the present invention.

The invention is shown schematically in the drawings using an embodiment and is described below with reference to the drawings.

### BRIEF DESCRIPTION OF THE DRAWINGS

FIG. 1 shows a preferred embodiment of an arrangement according to the invention, which arrangement is composed of a protective housing and a microtome blade in a perspective view, with the clip being in a first position;

FIG. 2 shows the embodiment of FIG. 1 in a perspective view, with the clip being in a second position;

FIG. 3 shows an enlarged section of the embodiment from FIGS. 1 and 2 in a perspective view;

FIG. 4 shows a preferred embodiment of a microtome blade holder according to the invention in a perspective view with the microtome blade and the protective housing from a first perspective; and

FIG. 5 shows the embodiment from FIG. 4 with a received arrangement composed of a protective housing and a microtome blade according to a preferred embodiment of the invention from a second perspective.

### DETAILED DESCRIPTION OF THE DISCLOSURE

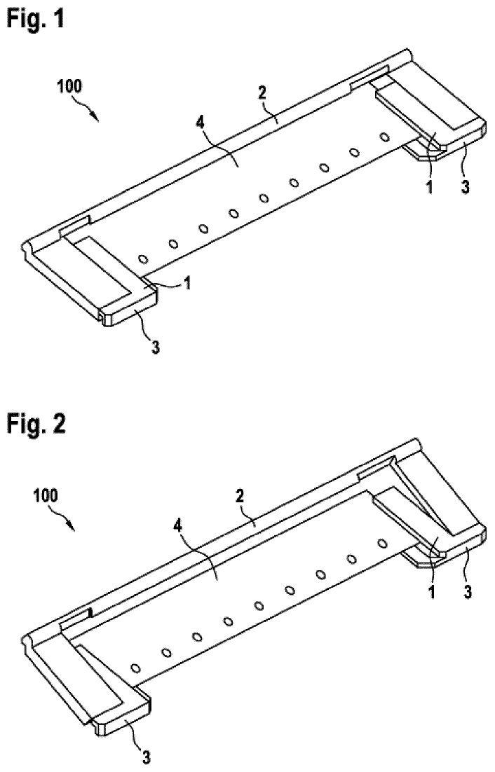

FIG. 1 shows a preferred embodiment of an arrangement according to the invention, which arrangement is composed of a microtome blade 4 and a protective housing and is denoted by 100.

The protective housing 100 in this case has a frame with two guide rails 1 and a clip 2 which connects the two guide rails 1 and is pivotable relative to the guide rails 1 or the frame.

The guide rails 1 in this case have elongated slots or grooves which are open on one side (the side facing away from the clip) for inserting the microtome blade 4 and have a stop on the other side (the side facing the clip) where the cutting edge is located. In this way, the microtome blade 4 can be inserted into the protective housing in a simple manner and yet very precisely. Due to the stop on the side facing the clip, a distance from the clip to the cutting edge of the microtome blade is always set correctly, regardless of the blade plane width of the microtome blade.

In this embodiment, the clip 2 is fastened to the guide rails 1 by means of hinges 3 which are designed in this case as film hinges. The clip in this case has a U-shape, with the entire protective housing also having a U-shape. This is a particularly good shape to ensure cutting edge coverage and minimal size at the same time. The protective housing 100 is made of plastics material, for example, in particular as an injection molded part. The clip is shown in FIG. 1 in a first position in which the clip 2 covers a cutting edge of the microtome blade 4. In this position, it can in particular be latched with at least one of the guide rails 1.

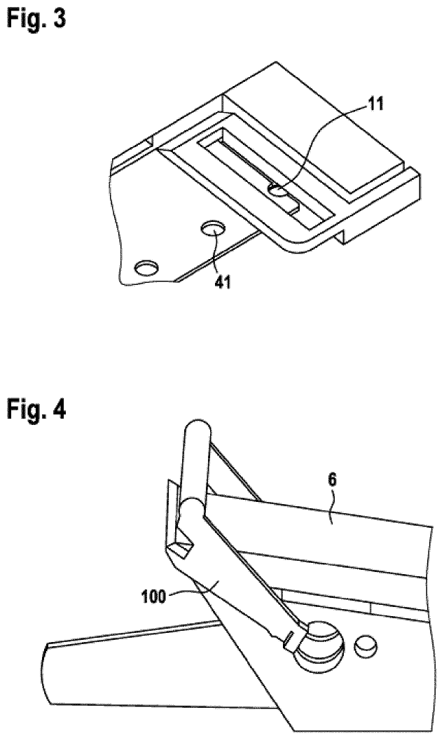

The clip 2 can be pivoted into a second position, which is shown in FIG. 2. In this position, it does not cover the cutting edge of the microtome blade 4. In this way, the protective housing can be advantageously used together with the microtome blade 4 for cutting operations without the protective housing having to be removed.

A covering surface of the clip 2, which covering surface covers the cutting edge of the microtome blade in the first position, is offset perpendicular to the blade plane by 0.1 to 3 mm in the second position. This distance is advantageous because it is sufficient to allow the cutting edge to be available for cutting operations but is still small enough to allow the clip 2 to protect against injuries on the cutting edge.

As can be seen in FIG. 3, in this embodiment the guide rails 1 have a latching lug 11 into which the microtome blade 4 can be latched. For this purpose, the microtome blade 4 has a corresponding recess 41 into which the latching lug can be latched. In this way, an unintentional slipping of the microtome blade 4 in the protective housing is advantageously avoided.

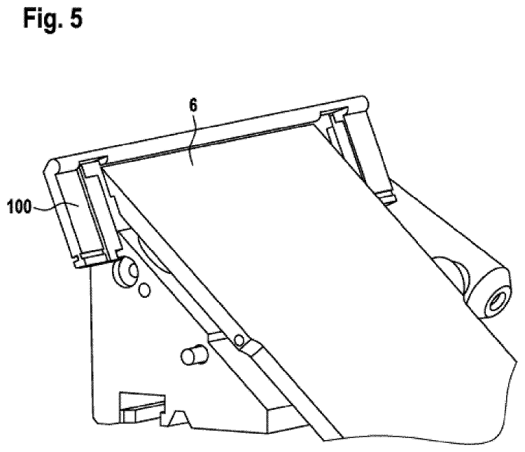

FIGS. 4 and 5 show a microtome blade holder 6 with a clamped arrangement 100 of microtome blade and protective housing from different directions. The clip of the protective housing

The microtome blade holder 6 is set up to receive an arrangement composed of a protective housing according to the invention and a microtome blade.

When the arrangement is inserted into the blade holder, the clip is automatically pressed into the second position by a corresponding mechanism, e.g. a spring-loaded lug or a stop on the blade holder, so that the cutting edge is released and the sample can be cut on the microtome. The cut material slides under the clip. The clip can also prevent the cut material from rolling up.

If the user slips down while handling the specimen head, he first touches the clip with his fingers and presses it down so that the finger does not come into contact with the cutting edge.

The protective housing on the blade holder is always visible in the inserted state. It is therefore preferably designed in a signal color (e.g. red), so that the user always recognizes immediately that a blade is inserted in the system and that it must be removed before cleaning work.

When removing the arrangement, the user can grasp the outside of the protective housing and safely remove the entire unit from the blade holder. In addition, he can latch the clip back into place so that the cutting edge is covered. As a result, the blade is harmless even in the used state.

What is claimed is:

1. A protective housing for a microtome blade (4), which housing comprises a frame that holds the microtome blade (4) and a clip (2) that can be pivoted relative to the frame and in a first position covers a cutting edge of the microtome blade (4) received in the frame.

2. The protective housing according to claim 1, wherein the clip (2) can be pivoted into a second position in which it does not cover the cutting edge of the microtome blade (4) received in the frame.

3. The protective housing according to claim 2, wherein a covering surface of the clip (2), which covering surface covers the cutting edge of the microtome blade (4) received in the frame in the first position, is offset perpendicular to a blade plane of the microtome blade (4) by 0.1 to 3 mm in the second position.

4. The protective housing according to claim 2, wherein the clip (2) is latched to the frame in the first and/or the second position.

5. The protective housing according to claim 1, wherein the clip (2) is fastened to the frame by means of hinges (3) which are preferably designed as film hinges.

6. The protective housing according to claim 1, wherein the frame has two guide rails (1) into which the microtome blade (4) can be inserted.

7. The protective housing according to claim 6, wherein the two guide rails (1) are designed as elongated grooves which are preferably open on one side for inserting the microtome blade (4) and on the other side have a stop which, when the microtome blade (4) is inserted, is on the side where the cutting edge is located.

8. The protective housing according to claim 6, wherein at least one of the two guide rails (1) has a latching lug (11) into which the microtome blade (4) is configured to be latched.

9. The protective housing according to claim 1, wherein the clip (2) has a U-shape, and the entire protective housing has a U-shape.

10. The protective housing according to claim 1, wherein the protective housing is open on an insertion side for the microtome blade (4).

11. The protective housing according to claim 1, wherein the protective housing is made of a plastics material.

12. The protective housing according to claim 1, wherein the protective housing is a one-piece injection molded part.

13. An arrangement (100) comprising:
a microtome blade (4); and
a protective housing comprising a frame that holds the microtome blade (4) and a clip (2) that can be pivoted relative to the frame and in a first position covers a cutting edge of the microtome blade (4) received in the frame.

14. The arrangement (100) according to claim 13, wherein the microtome blade (4) is non-detachably connected to the protective housing.

15. A microtome blade holder (6), configured to receive the arrangement (100) according to claim 13.

16. The microtome blade holder (6) according to claim 15, comprising a mechanism configured to automatically press the clip (2) from the first position to a second position when the arrangement (100) is received.
